(19) United States
(12) Patent Application Publication
(10) Pub. No.: US 2023/0260285 A1
(43) Pub. Date: Aug. 17, 2023

(54) A METHOD AND SYSTEM FOR TRACKING AND/OR MONITORING AN ACTIVITY

(71) Applicant: FISHCOIN (PTY) LTD, Launceston (AU)

(72) Inventors: Philippe Alexander Smith HØGSTEN, Hemsedal (NO); Joshua John WALKER, Launceston (AU)

(73) Assignee: FISHCOIN (PTY) LTD, Launceston (AU)

(21) Appl. No.: 18/015,201

(22) PCT Filed: Jul. 9, 2021
(86) PCT No.: PCT/IB2021/056184

§ 371 Date: Jan. 9, 2023

(30) Foreign Application Priority Data
Jul. 9, 2020 (ZA) 2020/04192

(51) Int. Cl. G06V 20/52; H04W 4/021; H04N 23/61; H04W 4/029

(52) U.S. Cl. CPC G06V 20/52; H04W 4/021; H04N 23/61; H04W 4/029

(57) ABSTRACT

A method and system for monitoring an activity. The system may include a mobile device and a control center being in at least transient electronic communication with each other, the system further including a first user profile accessed via the mobile device and a chronograph and global positioning system (GPS) tracking feature. The tracking feature is used to monitor a geographical location of a first user against passage of time and is configured to activate the first user profile when the first user is within a first predetermined distance from a location and to deactivate the first user profile when the user is within a second predetermined distance from the location. The invention extends to a method.

### FIELD OF INVENTION

This invention relates to a method and system for tracking and/or monitoring an activity.

### BACKGROUND

Many activities are conducted remotely away from urbanized environments and without access to human supervision and/or tele-communicative supervision. As such, certain activities that require measurement and/or quantification and/or qualification produce unreliable and/or unquantifiable data.

Primary economic activities are particularly difficult to monitor in remote locations. Fishing, mining, forestry and/or agricultural activities in remote locations are not readily monitored in regard to output. As such, ultimate beneficiaries find it difficult to determine productivity levels and/or the quality and/or quantity of primary economic output.

Further, tracking and/or monitoring activities may require electronic and/or electrical equipment which require electricity in order function. This equipment may be in communication with other means and/or the Internet requiring data. Remote areas often do not have ample facilities to recharge batteries needed to power this equipment. Furthermore, remote areas often do not have a Wi-Fi signal or connection to the Internet hampering monitoring and/or causing the equipment to constantly search for signal or connection which further accelerates the depletion of battery power.

There is a need not only to better track and/or monitor primary economic activities, particularly in remote locations, but also to better quantify and/or qualify the output of said activities and to better determine the productivity of said output. There is also a need to provide for systems and methods that will prolong equipment battery life and/or reduce the data size needed to fulfil tracking and/or monitoring activities.

Furthermore, theft of the output including fish, minerals, wood and/or agricultural produce is difficult to monitor, quantify and/or qualify in remote locations.

The invention described herein below strives to ameliorate at least one of the problems described above and/or otherwise known in the prior art.

### SUMMARY

Broadly, and in accordance with a first aspect of this invention there is provided a system for tracking and/or monitoring an activity, the system comprising a mobile device and a control center, the mobile device and control center being in at least transient electronic communication with each other and wherein the system includes:
a first user profile accessed via the mobile device;
a chronograph and global positioning system (GPS) tracking means to monitor a geographical location of a first user against passage of time, the tracking means configured to activate the first user profile when said first user is within a first predetermined distance from a location and to deactivate the first user profile when said user is within a second predetermined distance from the location,
   such that the activation of the first user profile enables the first user to electronically communicate with a second and/or subsequent user and its respective second and/or subsequent user profiles when the mobile device is in an online state connected to a wireless mobile network allowing an exchange of online data between first and second and/or subsequent users; and/or
   such that the activation of the first user profile facilitates the first user to store data on the mobile device as recorded data when the mobile device is in an offline state not connected to the wireless mobile network;
a synchronization module in electronic communication with the mobile device and the control center, the synchronization module being configured to receive recorded data from the mobile device when said mobile device is altered from an offline state into an online state and to update the first user profile online data with the recorded data;
a camera in electronic communication with the first user profile when said first user profile is activated, wherein the camera being configured to capture a first image of a first object and to determine its properties including at least one of, but not limited to, the group: species, size, weight, volume, geolocation, and time of capture, and wherein the camera is configured to capture a second and/or subsequent image of a second or subsequent object (and to determine its properties) only after an elapse of a predetermined period of time after the capture and property determination of the first object,
a database connected to the first user profile and the control center which includes output information comprising the properties of the first and/or subsequent objects;
such that in use, the monitoring system allows the activity to be monitored whilst quantifying and/or qualifying the output information.

The Applicant has found that the synchronization module being configured to receive recorded data from the mobile device when said mobile device is altered from an offline state into an online state and to update the first user profile online data with the recorded data increases battery life of the mobile device which otherwise continually uses power to search for a Wi-Fi or Internet signal. This is advantageous in a remote setting far away from power sources.

The camera is configured to capture a second and/or subsequent image of a second or subsequent object (and to determine its properties) only after an elapse of a predetermined period of time after the capture and property determination of the first object, and this facilitates not only more accurate monitoring by avoiding duplication but in turn also reduces data usage. This feature allows an employer to accurately track and/or monitor an activity as an employee cannot easily fake activity and to include fake entries into the database.

The tracking means is configured to activate the first user profile when said first user is within a first predetermined distance from a location and to deactivate the first user profile when said user is within a second predetermined distance from the location. This facilitates reducing fake entries into the database and/or reduces data usage by avoiding duplicate and/or fake entries. This feature therein facilitates increasing battery life.

The control center may be cloud based and/or may include a physical server.

The location may be at least one of, but not limited to, the following group: a mine, a forest, a crop, a herd of beasts, a body of water. Preferably, the location is a body of water. The body of water may be a freshwater body or a saltwater body. Further preferably, the body of water may be a stream, a river, a lake, a sea and/or an ocean.

The first predetermined distance is less than the second predetermined distance relative to the location. The first predetermined distance may be a range between zero and 20 meters, preferably a range between zero and 10 meters, from the location. The second predetermined distance may be greater than 20 meters, preferably, greater than 10 meters, from the location.

The object may be an animal including, but not limited to, the group: fish, reptile, amphibian, insect, bird, mammal and marsupial. The object may be a plant including, but not limited to, the group: fungi, gymnosperm, angiosperm, monocotyledon and dicotyledon. The object may be a mineral, including but not limited to, the group: copper, gold, silver, iron, titanium, tin, zinc, manganese, diamond, precious metal, semi-precious metal and gem. Preferably, the object is a fish, and the fish may be a freshwater or a saltwater fish.

The properties of the object may further include identification. Identification may include determination of mineral type, plant type, animal type. Preferably, identification includes the determination of species (including plant and/or animal species).

The camera may be configured to include a self-recognition of previous images to avoid capturing and/or collecting duplicate data. The images may be a series of images and may include a video.

The system may further include a scoring means, the scoring means assigning a value to the first and/or second and/or subsequent object based on its property.

The scoring system may be in electronic communication with the control center and/or the database. The scoring system may facilitate qualitative comparison between dissimilar objects to determine productivity of different users. The productivity may be ranked. The rank may be awarded. For example, a saltwater fish of a certain size will qualitatively be scored lower than a freshwater fish of the same size; and a mined quantity of gold containing ore will qualitatively be scored high than a same quantity of mined iron ore. A qualitative comparison may include weighting the properties of objects. Similarly, a certain species might score higher relative to another species, and this may be linked to the scarcity of said species and/or the difficulty associated with catching and/or locating and/or harvesting such species. Species identification may result from a link to a database of images and/or images of fish species on the Internet and/or related machine learning.

The predetermined period of time may be greater than 30 seconds, preferably greater than 2 minutes, further preferably greater than 3 minutes. The predetermined period of time prevents the same object from being captured twice therein avoiding any unfair score and/or cumulative score attributed to a specific user profile or portion thereof

The system may be enabled via a mobile application. The mobile application may be activated when the first user profile is activated. Additionally, and/or alternatively, the mobile application may activate certain aspects of its functionality when the first user profile is activated, and may deactivate certain aspects of its functionality when the first user profile is deactivated.

When the first user profile is activated the first user may determine the property(ies) of objects for inclusion into the database. Each user profile may have its own database. Additionally, or alternatively, each user profile may contribute to a central database linked to the control center.

It is to be understood, that the properties of objects may be scored, and scores of different objects compared by interrogation of the database (individual user databases, additionally and/or alternatively, the central database). Higher value scores may be rewarded. Rewards may be monetary.

Broadly, and in accordance with a second aspect of this invention there is provided a method for tracking and/or monitoring an activity, the method comprising utilization of the system according to the first aspect herein above.

There is provided a method for tracking and/or monitoring an activity, the method comprising the following steps:
establishing a first user profile via a mobile device of a first user wherein the mobile device is in at least transient electronic communication with a control center;
providing a chronograph and global positioning system (GPS) tracking means to monitor a geographical location of the first user against passage of time, the tracking means configured to activate the first user profile when said first user is within a first predetermined distance from a location and to deactivate the first user profile when said user is within a second predetermined distance from the location,
such that the activation of the first user profile enables the first user to electronically communicate with a second and/or subsequent user and its respective second and/or subsequent user profiles when the mobile device is in an online state connected to a wireless mobile network allowing an exchange of online data between first and second and/or subsequent users; and/or
such that the activation of the first user profile facilitates the first user to store data on the mobile device as recorded data when the mobile device is in an offline state not connected to the wireless mobile network;
optionally synchronizing recorded data with online data via a synchronization module which in electronic communication with the mobile device and the control center, the synchronization module being configured to receive recorded data from the mobile device when said mobile device is altered from an offline state into an online state and to update the first user profile online data with the recorded data;
capturing an image of a first object with a camera being in electronic communication with the first user profile when said first user profile is activated, wherein the camera being configured to determine properties of the first object including at least one of, but not limited to, the group: species, size, weight, volume, geolocation, and time of capture, and wherein the camera is configured to capture a second and/or subsequent image of a second and/or subsequent object (and to determine its properties) only after an elapse of a predetermined period of time after the capture and property determination of the first object,
collecting, in a database connected to the first user profile and the control center, output information comprising the properties of the first and/or subsequent objects;
such that in use, the method allows the activity to be monitored whilst quantifying and/or qualifying the output information.

The control center may be cloud based and/or may include a physical server.

The location may be at least one of, but not limited to, the following group: a mine, a forest, a crop, a herd of beasts, a body of water. Preferably, the location is a body of water. The body of water may be a freshwater body or a saltwater body. Further preferably, the body of water may be a stream, a river, a lake, a sea and/or an ocean.

The first predetermined distance is less than the second predetermined distance relative to the location. The first predetermined distance may be a range between zero and 20 meters, preferably a range between zero and 10 meters, from the location. The second predetermined distance may be greater than 20 meters, preferably, greater than 10 meters, from the location.

The object may be an animal including, but not limited to, the group: fish, reptile, amphibian, insect, bird, mammal and marsupial. The object may be a plant including, but not limited to, the group: fungi, gymnosperm, angiosperm, monocotyledon and dicotyledon. The object may be a mineral, including but not limited to, the group: copper, gold, silver, iron, titanium, tin, zinc, manganese, diamond, precious metal, semi-precious metal and gem. Preferably, the object is a fish, and the fish may be a freshwater or a saltwater fish.

The properties of the object may further include identification. Identification may include determination of mineral type, plant type, animal type. Preferably, identification includes the determination of species (including animal and/or plant species).

The camera may be configured to include a self-recognition of previous images to avoid capturing and/or collecting duplicate data. The images may be a series of images and may include a video.

The method may further include a step of scoring via a scoring means, the scoring means assigning a value to the first and/or second and/or subsequent object based on its property(ies).

The scoring system may be in electronic communication with the control center and/or the database. The scoring system may facilitate qualitative comparison between dissimilar objects to determine productivity of different users. The productivity may be ranked. The rank may be awarded.

For example, a saltwater fish of a certain size will qualitatively be scored lower than a freshwater fish of the same size; and a mined quantity of gold containing ore will qualitatively be scored high than a same quantity of mined iron ore. A qualitative comparison may include weighting the properties of objects. Similarly, a certain species might score higher relative to another species, and this may be linked to the scarcity of said species and/or the difficulty associated with catching such species. Species identification may result from a link to a database of images and/or images of fish species on the Internet and/or related machine learning.

The predetermined period of time may be greater than 30 seconds, preferably greater than 2 minutes, further preferably greater than 3 minutes. The predetermined period of time prevents the same object from being captured twice therein avoiding any unfair score and/or cumulative score attributed to a specific user profile or portion thereof.

The method may be enabled via a mobile application. The mobile application may be activated when the first user profile is activated. Additionally, and/or alternatively, the mobile application may activate certain aspects of its functionality when the first user profile is activated, and may deactivate certain aspects of its functionality when the first user profile is deactivated.

When the first user profile is activated the first user may determine the property(ies) of objects for inclusion into the database. Each user profile may have its own database. Additionally, or alternatively, each user profile may contribute to a central database linked to the control center.

It is to be understood, that the properties of objects may be scored, and scores of different objects compared by interrogation of the database (individual user databases, additionally and/or alternatively, the central database). Higher value scores may be rewarded. Rewards may be monetary.

There is further provided for a method and a system substantially as herein described, illustrated and/or exemplified.

### DETAILED DESCRIPTION OF THE INVENTION

The Summary of the invention is repeated hereunder by way of reference only to avoid repetition. Only specific embodiments of the invention are described in detail herein below, but these should not be viewed as limiting the scope of the invention.

Primary economic activities are difficult to measure quantitatively and/or qualitatively in remote areas. This is particularly true for primary activities conducted by individuals and/or small groups as opposed to several individuals together or in large groups. For example, prospecting a new mining interest, locating new fishing grounds, harvesting remote forests, herding remote livestock and the like, are all examples of such primary activities.

There is provided, in accordance with a first aspect of this invention, a system for tracking and/or monitoring an activity. The system comprises a mobile device and a control center, and wherein the mobile device and control center being in at least transient electronic communication with each other. Typically, the control center is hosted remotely on a server and/or is cloud based.

The system is enabled via a mobile application or app. A first user downloads the app from an app store onto his/her mobile device. Certain programming code enabling certain functionalities may be downloaded and installed onto the mobile device to enable offline functionalities. Other programming code enabling other functionalities may be located on the control center and may be accessed only when online. Typically, the control center and the app downloaded onto the mobile phone may be in at least transient electronic communication with each other.

Typically, the system according to the first aspect of this invention includes a first user profile which is accessed via the mobile device. The system includes a tracking means being a chronograph and global positioning system (GPS). The tracking means monitors a geographical location of the first user against passage of time. The tracking means monitors the geographical location of the first user when the mobile device has a wireless internet signal and/or when it does not.

The tracking means is configured to activate certain functionalities of the first user profile of the downloaded app only when the first user is within a first predetermined distance from a location. Similarly, the tracking means is configured to deactivate certain functionalities of the first user profile of the downloaded app when the first user is within a second predetermined distance from the location. For example, the in an embodiment where the activity is fishing, the certain functionalities of the first user profile of the downloaded app will only activate when the tracking means determines that the first user is within a certain distance from a body of water where the activity of fishing may take place. In other words, should the first user be within a range of between about zero to about 20 meters, preferably between about zero and about 10 meters of the body of water, only then will certain functionalities of the first user profile of the downloaded app be activated. The tracking means determines this by determining the geolocation of the first user and against the activity to be conducted. It is to be understood that the body of water may be freshwater or saltwater, a dam, river, stream, pond, sea or ocean, all by way of example only.

The activation of the first user profile enables certain functionalities of the first user profile of the downloaded app. These include the ability of the first user to electronically communicate with a second and/or subsequent user and its respective second and/or subsequent user profiles.

The ability of the first user to communicate with a second user occurs when both first and second users have activated user profiles. Naturally, this may extend to communication with subsequent other users who have activated user profiles. This electronic communication is via a wireless internet connection typically facilitated by a telecommunications network, and is facilitated when the mobile device of the first user is in an online state connected to a wireless mobile network allowing an exchange of online data between first and second and/or subsequent users. This exchange of information takes place in real time via the wireless mobile network. As such, the first and second (or subsequent) users all having activated user profiles communicate with one another regarding their activity which is explained in further detail below.

In remote locations access to wireless mobile networks (or other internet providing networks) is often limited. As such, the first user may not be in a position to communicate in real time with a second or subsequent user. However, it might still remain important for the first user to log and/or store and/or compile information and/or data about his/her activity during the time of not having internet access. To this end, the activation of the first user profile facilitates the first user to store data on the mobile device as so-called recorded data when the mobile device is in an offline state not connected to the wireless mobile network.

To ensure collation of all available data, it is imperative to synchronize any online data with recorded data. As such, the system further includes a synchronization module in electronic communication with the mobile device and the control center. The synchronization module is configured to receive recorded data from the mobile device when said mobile device is altered from an offline state into an online state. When the mobile device is again online, all the recorded data is provided to update the first user profile online data. This will allow the first user to communication with the second and/or subsequent user, and will allow the first user to share information and/or data with the second and/or subsequent user. In certain embodiments of the invention, certain functionalities of the app are processed and/or enabled by the control center, additionally and/or alternatively, by the portion of code downloaded onto the mobile device. As such, the synchronization of the recorded data to update the first user profile may take place in part on the mobile device hardware and in part on the control center. In other embodiment, the synchronization of the recorded data to update the first user profile takes place entirely on the mobile device hardware, alternatively, entirely on the control center. A split between the mobile device hardware and the control center increases short term efficiencies in regard to speed and data usage. Over time, and depending on available bandwidth and data costs, the system is configured to send all recorded data in defined quanta of data packages to the control center to maximize efficiencies but minimize data costs.

The system further includes a camera in electronic communication with the first user profile when said first user profile is activated. Since the camera will be utilized to capture images of the primary activity in order to qualify and/or quantify same, camera activation only when the user profile is activated (when at a predetermined distance from the location of the activity) ensures no false or fake activity is measured, gathered, quantified and/or qualified.

The camera is configured to capture a first image of a first object and to determine its properties including at least one of, but not limited to, the group: species, size, weight, volume, geolocation, and time of capture. The camera is configured to capture a second and/or subsequent image of a second or subsequent object (and to determine its properties) only after an elapse of a predetermined period of time after the capture and property determination of the first object. The necessary elapse of the predetermined time period hinders duplicate image capture and/or collection.

The camera is configured to include a self-recognition of previous images to avoid capturing and/or collecting duplicate data.

The properties of the object may further include identification. Identification may include determination of mineral type, plant type, animal type. Preferably, identification includes the determination of fish species.

The system may further include a database connected to the first user profile and the control center which includes output information comprising the properties of the first and/or subsequent objects.

The database may be located on the mobile device or on the control center or partially on both. In a case of multiple user profiles the information and/or data from various users can be compared.

The location may be at least one of, but not limited to, the following group: a mine, a forest, a crop, a herd of beasts, a body of water. Preferably, the location is a body of water. The body of water may be a freshwater body or a saltwater body. Further preferably, the body of water may be a stream, a river, a lake, a sea and/or an ocean.

The first predetermined distance is less than the second predetermined distance relative to the location. The first predetermined distance may be a range between zero and 20 meters, preferably a range between zero and 10 meters, from the location. The second predetermined distance may be greater than 20 meters, preferably, greater than 10 meters, from the location.

The object may be an animal including, but not limited to, the group: fish, reptile, amphibian, insect, bird, mammal and marsupial. The object may be a plant including, but not limited to, the group: fungi, gymnosperm, angiosperm, monocotyledon and dicotyledon. The object may be a mineral, including but not limited to, the group: copper, gold, silver, iron, titanium, tin, zinc, manganese, diamond, precious metal, semi-precious metal and gem. Preferably, the object is a fish, and the fish may be a freshwater or a saltwater fish.

The system may further include a scoring means, the scoring means assigning a value to the first and/or second and/or subsequent object based on its property or properties. The scoring system may weight particular properties.

The scoring system may be in electronic communication with the control center and/or the database. The scoring system may facilitate qualitative comparison between dissimilar objects to determine productivity of different users. For example, productivity may be related to economic benefit, and 1 kg of gold containing ore might be economically worth more than 10 kg of iron ore. Or a 5 kg salmon might fetch a higher market price than a 5 kg hake.

The productivity may be ranked. Ranking information may be utilized to determine locations of higher yield. Ranking may be utilized to identify users of greater and lower efficiencies.

The rank may be awarded. For example, a saltwater fish of a certain size will qualitatively be scored lower than a freshwater fish of the same size; and a mined quantity of gold containing ore will qualitatively be scored high than a same quantity of mined iron ore. A qualitative comparison may include weighting the properties of objects. Similarly, a certain species might score higher relative to another species, and this may be linked to the scarcity of said species and/or the difficulty associated with catching such species. Species identification may result from a link to a database of images and/or images of fish species on the Internet and/or related machine learning.

The predetermined period of time may be greater than 30 seconds, preferably greater than 2 minutes, further preferably greater than 3 minutes. The predetermined period of time prevents the same object from being captured twice therein avoiding any unfair score and/or cumulative score attributed to a specific user profile or portion thereof.

It is to be understood, that the properties of objects may be scored, and scores of different objects compared by interrogation of the database (individual user databases, additionally and/or alternatively, the central database). Higher value scores may be rewarded. Rewards may be monetary.

When the system is in use, the monitoring system allows the activity to be monitored whilst quantifying and/or qualifying the output information. The system allows multiple users to gather and compare data online and offline and the tracking means prevents any user from falsifying activity. The necessary elapse of the predetermined time period hinders duplicate image capture and/or collection and hinders falsifying activity. The system provides for a more accurate means to monitor an activity in a quantitative and/or qualitative manner This also reduces data usage of the mobile device and reduces the need to more memory and/or storage in the database.

The Applicant has found that the synchronization module being configured to receive recorded data from the mobile device when said mobile device is altered from an offline state into an online state and to update the first user profile online data with the recorded data increases battery life of the mobile device which otherwise continually uses power to search for a Wi-Fi or Internet signal. This is advantageous in a remote setting far away from power sources.

The camera is configured to capture a second and/or subsequent image of a second or subsequent object (and to determine its properties) only after an elapse of a predetermined period of time after the capture and property determination of the first object, and this facilitates not only more accurate monitoring by avoiding duplication but in turn also reduces data usage. This feature allows an employer to accurately track and/or monitor an activity as an employee cannot easily fake activity and to include fake entries into the database.

The tracking means is configured to activate the first user profile when said first user is within a first predetermined distance from a location and to deactivate the first user profile when said user is within a second predetermined distance from the location. This facilitates reducing fake entries into the database and/or reduces data usage by avoiding duplicate and/or fake entries. This feature therein facilitates increasing battery life.

The Applicant believes that the disclosures of this invention at least ameliorates the disadvantages known or described in the prior art. The Applicant believes the invention described herein includes novel and innovative features which together provide a solution to accurately, quantitatively and/or qualitatively tracking and/or monitoring activities whilst reducing data usage and increasing battery life of electronic means such as the mobile device.

While the disclosure has been described in detail with respect to specific embodiments and/or examples thereof, it will be appreciated that those skilled in the art, upon attaining an understanding of the foregoing may readily conceive of alterations to, variations of and equivalents to these embodiments. Accordingly, the scope of the present disclosure should be assessed as that of the claims and any equivalents thereto, which claims are appended to this patent application.

1. A system for tracking and/or monitoring an activity, the system comprising a mobile device and a control center, the mobile device and control center being in at least transient electronic communication with each other and wherein the system includes:
a first user profile accessed via the mobile device;
a chronograph and global positioning system (GPS) tracking means to monitor a geographical location of a first user against passage of time, the tracking means configured to activate the first user profile when said first user is within a first predetermined distance from a location and to deactivate the first user profile when said user is within a second predetermined distance from the location,
such that the activation of the first user profile enables the first user to electronically communicate with a second and/or subsequent user and its respective second and/or subsequent user profiles when the mobile device is in an online state connected to a wireless mobile network allowing an exchange of online data between first and second and/or subsequent users; and
such that the activation of the first user profile facilitates the first user to store data on the mobile device as recorded data when the mobile device is in an offline state not connected to the wireless mobile network;
a synchronization module in electronic communication with the mobile device and the control center, the synchronization module being configured to receive recorded data from the mobile device when said mobile device is altered from an offline state into an online state and to update the first user profile online data with the recorded data;
a camera in electronic communication with the first user profile when said first user profile is activated, wherein the camera being configured to capture a first image of a first object and to determine its properties including at least one of the group consisting of: the group: species, size, weight, volume, geolocation, and time of capture, and wherein the camera is configured to capture a second and/or subsequent image of a second or subsequent object (and to determine its properties) only after an elapse of a predetermined period of time after the capture and property determination of the first object,
a database connected to the first user profile and the control center which includes output information comprising the properties of the first and/or subsequent objects;
such that in use, the monitoring system allows the activity to be monitored whilst quantifying and/or qualifying the output information.

2. The system for tracking and/or monitoring an activity according to claim 1, wherein the control center is cloud based and/or includes a physical server.

3. The system for tracking and/or monitoring an activity according to claim 1, wherein the location is at least one of the following group consisting of: a mine, a forest, a crop, a herd of beasts, a body of water.

4. The system for tracking and/or monitoring an activity according to claim 1, wherein the first predetermined distance is less than the second predetermined distance relative to the location.

5. The system for tracking and/or monitoring an activity according to claim 1, wherein the first predetermined distance is a range of between zero and 20 meters from the location, and wherein the second predetermined distance is greater than 20 meters from the location.

6. The system for tracking and/or monitoring an activity according to claim 1, wherein the object is an animal including at least one the group consisting of: fish, reptile, amphibian, insect, bird, mammal and marsupial.

7. The system for tracking and/or monitoring an activity according to claim 1, wherein the object is a plant including at least one the group consisting of: fungi, gymnosperm, angiosperm, monocotyledon and dicotyledon.

8. The system for tracking and/or monitoring an activity according to claim 1, wherein the object is a mineral, including at least one the group consisting of: copper, gold, silver, iron, titanium, tin, zinc, manganese, diamond, precious metal, semi-precious metal and gem.

9. The system for tracking and/or monitoring an activity according to claim 1, wherein the properties of the object include identification, and identification includes determination of mineral type, plant type, or animal type.

10. The system for tracking and/or monitoring an activity according to claim 1, wherein the camera is configured to include self-recognition capability of previous images such that any previously captured image will not be processed as online data or recorded date and, in so doing, avoids capturing and/or collecting duplicate data.

11. The system for tracking and/or monitoring an activity according to claim 1, wherein the system further comprises a scoring means, the scoring means assigning a value to the first and/or second and/or subsequent object based on its property.

12. The system for tracking and/or monitoring an activity according to claim 11, wherein the scoring system is in electronic communication with the control center and/or the database, and wherein the scoring system facilitates qualitative comparison between dissimilar objects to determine productivity of different users.

13. The system for tracking and/or monitoring an activity according to claim 12, wherein the productivity is ranked.

14. The system for tracking and/or monitoring an activity according to claim 1, wherein the predetermined period of time is greater than 30 seconds.

15-29. (canceled)

30. The system for tracking andor monitoring an activity according to claim 1, wherein the predetermined period of time is greater than 2 minutes.

31. The system for tracking andor monitoring an activity according to claim 1, wherein the predetermined period of time is greater than 3 minutes.

32. The system for tracking andor monitoring an activity according to claim 1, wherein the the first predetermined distance is a range of between zero and 10 meters from the location, and wherein the second predetermined distance is greater than 10 meters from the location.
